(19) United States
(12) Patent Application Publication
(10) Pub. No.: US 2012/0013110 A1
(43) Pub. Date: Jan. 19, 2012

(54) Anchoring System For Emergency Rescue Vehicle

(76) Inventors: Morgan Nye, Corydon, IN (US); Stacy Mattenley, Corydon, IN (US)

(21) Appl. No.: 13/185,239

(22) Filed: Jul. 18, 2011

Related U.S. Application Data
(60) Provisional application No. 61/365,404, filed on Jul. 19, 2010.

(51) Int. Cl. B60R 99/00

(52) U.S. Cl. 280/762

(57) ABSTRACT

Some emergency rescue situations require rescue workers to rappel or otherwise use climbing ropes to accomplish a rescue. Safety laws and regulations require that a rescue worker tie off, or anchor, to three separate anchor points, before going over an edge or down a steep grade on a rescue. The three separate anchor points provides redundancy for safety. The current invention provides anchor points mounted directly on vehicles driven by emergency personnel, typically emergency vehicles. Some embodiments of the invention can be easily retrofitted to emergency vehicles. Other embodiments may be employed in other applications resulting in additional variations to those embodiments.

### CROSS REFERENCE TO RELATED APPLICATIONS

This invention claims priority from provisional patent application 61/365,404 titled “Emergency Vehicle With Anchoring System For Rescue” filed on Jul. 19, 2010.

### FIELD OF INVENTION

The present application is generally related to providing anchor points for rescue on an emergency vehicle. More particularly, the anchor points are attached to the emergency vehicle and provide three points for anchoring for rope rescue situations.

### BACKGROUND

In many emergency situations, some type of rescue is required. For example, if a car has gone off the road down a steep embankment, rescue workers will need to obtain access to the vehicle, and when the embankment is steep enough, ropes will need to be used to obtain that access. In such situations, proper safety procedures require that each individual using rope to go over the edge must be able to anchor themselves at three satisfactory anchor points. This can be a challenging requirement at many rescue sites and, at a minimum, can cause delay at a time when delay is life threatening. Embodiments of the present invention provide a system where three dependable anchor points are easily available, as they are attached to the emergency vehicle. This means that anywhere an emergency vehicle outfitted with the system goes; a sufficient means of anchoring a rescue worker is available. In some embodiments, the system is applied to both sides of the vehicle and therefore two sets of anchor points are available.

### RELATED ART

U.S. Pat. No. 6,401,863 by Kirkland is for a “Multi-purpose portable davit anchoring system”. A new multi-purpose portable davit anchoring system is provided, having a sectional vertical support mast which comes apart for compact stowage and is easily reassembled. The support mast incorporates a screw jack assembly which adjusts the height of the mast and biases the support mast between two opposing surfaces, such as a floor and ceiling. The biasing action enables it to be firmly yet removably attached to a building wherein the exterior walls are not load-bearing but merely sheathing, and to provide support for a damaged ceiling that might otherwise collapse. A boom member is removably fastened to the support mast, for deploying a lifting and lowering cable away from the side of the building. A mounting plate is provided for a winch assembly that can wind up the cable or release it at a controlled rate of speed. Low profile upper and lower brackets for receiving the ends of the support mast are optionally permanently mounted at several locations on each floor of the building with minimal effect on the appearance of the building.

U.S. Pat. No. 5,544,363 by McCue, et al. is for an “Ambulance attendant's safety vest and harness.” A vest and harness combination is disclosed comprising a sleeveless vest formed of a fabric material for covering the shoulders, front and back of a wearer. A harness comprising two pairs of spaced webs is secured to said vest. The first pair of spaced webs is attached to and extends longitudinally along the front of said vest. The second pair of spaced webs is attached to said vest and extends laterally of said first pair of webs at least partially around the vest. The first pair of webs extends over the shoulders of said vest, criss-crosses the back of said vest and is fastened to opposite sides thereof. The first pair of webs at the point of criss crossing is provided with a slotted ring-like frame through which each of the first pair of webs extends. One of the pair of webs is provided with a second slotted ring-like frame at a point midway of the back of the vest. The other of said second pair of webs is provided with a slotted buckle at one end and a clasp at its other end for engaging said buckle. A plurality of paired ring-like frames is attached to the front of the harness. Each of the first, second and the plurality of paired ring-like frames is detachably connectable to a retractable wall mountable reel for containment of the user of the vest and harness combination in a limited movable position. Further, each of said plurality of ring-like frames is detachably connectable to a variety of accessories.

### SUMMARY OF EMBODIMENTS OF THE INVENTION

Embodiments of the present invention provide anchor points on an emergency vehicle to facilitate rope rescue. The anchor points are attached to the vehicle and therefore provide portable but solid anchor points at the site of a rescue at any time a vehicle with the system is on site at a rescue.

In at least one embodiment of the present invention, an anchoring system is set forth for use with a vehicle. The anchoring system includes a plurality of anchoring points that can be used to ties ropes, cords or other anchoring members. Preferably, at least one anchoring point can be placed at or near the top of the vehicle such that it can be elevated from ground level. One or more other anchoring points can be located at or near the bottom side of the vehicle. In yet another embodiment, the anchoring points may terminate with an eye loop. In yet another embodiment, one or more of the anchoring points may be extendable from the base of the vehicle.

In at least one embodiment of the system, two of the anchor points on each side of the vehicle consist of elongated arms that attach to the frame of the vehicle and extend from beneath the vehicle to the outer edge of the respective side of the vehicle. In one embodiment of these two lower anchor points on one side of a vehicle, one anchor point is forward of the rear wheel, while the other one of these two anchor points is behind the rear wheel. A third anchor point is positioned at, or near, the top edge of the side of the vehicle. This anchor point is bolted or screwed to the side of the vehicle and is paired with an anchor point on the opposite side of the vehicle. The anchor point on the opposite side of the vehicle is similarly screwed or bolted to the side of the emergency vehicle and a cross tie bar runs across the top of the vehicle and is joined with the anchor point on each side. This provides additional support to the top anchor point beyond the bolts and screws and generates a holding capacity above the tensile load sustainable by the bolts and screws on just one side of the vehicle. The interaction between the cross tie bar and upper anchor points on each side can convert a load on the anchor to a compression load at the screws attaching the upper anchor point to the vehicle. Along with the upper anchor on the opposite side of the vehicle, the opposite side of the vehicle may have lower anchor points symmetric with those previously described at the lower edge of the side of the vehicle.

### DESCRIPTION OF THE DRAWING FIGURES

FIG. 1 is a perspective view of an emergency vehicle with the anchor system shown installed on the vehicle with three anchor points most visible on one side of the vehicle.

FIG. 2 is a section view at line 2-2 of FIG. 1 of the vehicle showing the attachment of the lower anchors to the frame.

FIG. 3 is a perspective view of the elements of the upper anchor assembly with a section of the cross tie bar shown.

FIG. 4 is a perspective view of the upper anchor assembly assembled onto the emergency vehicle.

FIG. 5 is a perspective view of elements of an embodiment of the lower anchor not attached to a vehicle.

### DETAILED DESCRIPTION OF EMBODIMENTS OF THE INVENTION

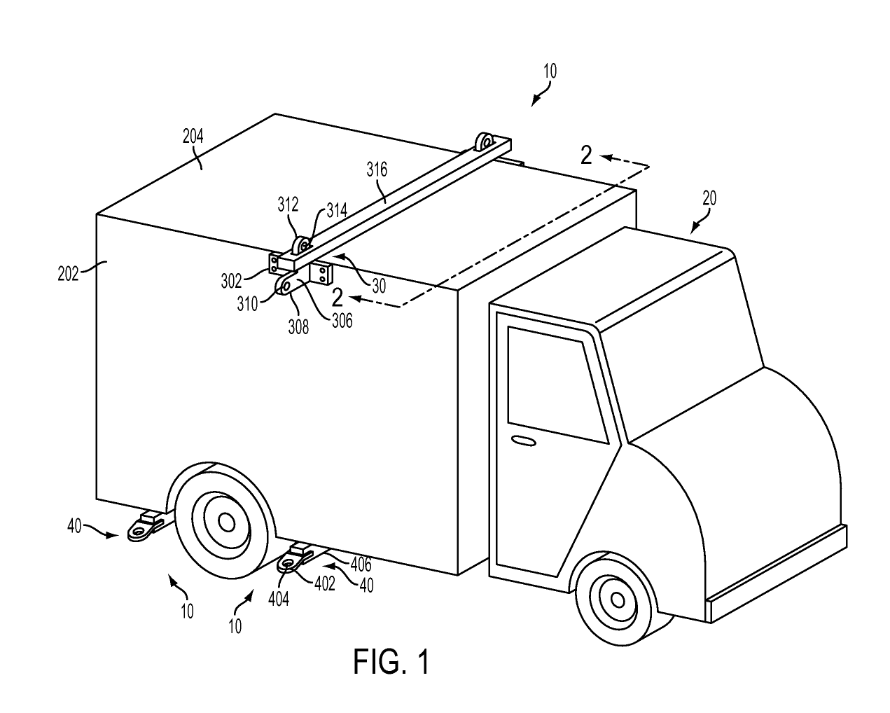

FIG. 1 is a perspective view of the anchor points system 10 for rescue workers attached to an emergency vehicle 20. The system is comprised of two lower anchors points 40 with one of the lower anchor points 40 being in front of the rear wheel and the other lower anchor point 40 being behind the rear wheel and both of the lower anchor points 40 extending slightly from the emergency vehicle 20 just below its side 202. The third anchor point on a side is located at the top edge of the emergency vehicle 20. This upper anchor point 30 is attached to the side 202 of emergency vehicle 20 and is reinforced by cross tie bar 316 to a matching upper anchor point 30 on the other side of emergency vehicle 20. At each anchor point, apertures are presented to which ropes may be attached. Lower anchor tabs 402 have lower anchor apertures 404 through them, while upper anchor tabs 308 have upper anchor apertures 310 through them. Two sets of three anchor points are thereby established on each side of the emergency vehicle 20 with anchor point system 10.

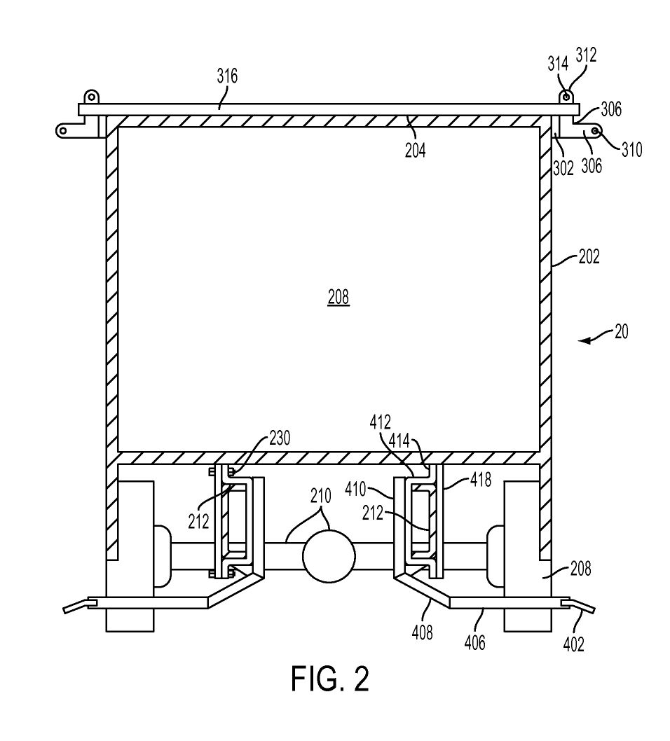

FIG. 2 is a sectional view of the emergency vehicle 20 shown in FIG. 1 at the line 2-2 shown in FIG. 1. Several common components of emergency vehicle 20 may be seen in this sectional view. The overall shape of the body is shown by sides 202 and top 204 which enclose an interior 206 at the section line 2-2 of FIG. 1. FIG. 2 shows the anchor point system 10 on both sides of emergency vehicle 20. At the top, upper anchor points 30 are shown on each side, and cross tie bar 316 connects to each anchor point 30 on both sides 202 of emergency vehicle 20 to reinforce the mounts of upper anchor points 30.

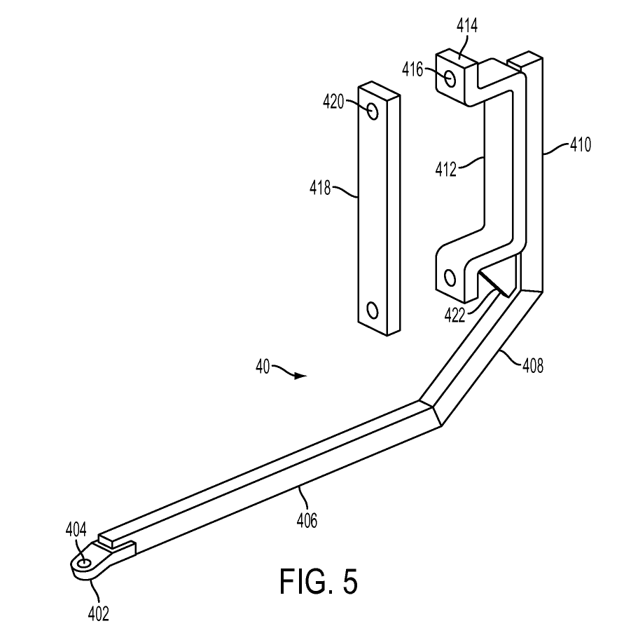

Again in FIG. 2, beneath the body of vehicle 20, parts of the drive train may be seen and is depicted at tires 208 with drive elements 210 connecting to and driving tires 208. Also visible in FIG. 2 are a sectional view of frame elements 212. To provide an extremely strong and reliable foundation for lower anchor assemblies 40, it is to these frame elements 212 that lower anchor assemblies 40 are attached. The location of lower anchor tab 402 with respect to the bottom edge of side 202 may be seen. This location provides convenient and quick access. Extending back under the emergency vehicle 20 from lower anchor tab 402 is lower anchor extension 406. Lower anchor extension 406 extends back under the body of emergency vehicle 20 until it joins angled riser 408 which in turn attaches to vertical riser 410. Vertical riser 410 rises vertically in proximity to frame member 212. Attached to vertical riser 410 is frame engagement member 412 which is shaped to partially envelop frame member 212 of vehicle 20. Frame capture member 418 joins with frame engagement member 412 to encircle frame element 212 and thereby mount lower anchor assembly 40 to frame element 212. As will be seen from discussion of FIG. 5, frame engagement member 412 and frame capture member 418 typically have matching bolt apertures through them and are joined together by bolts. Bolts 230 may be seen in the left hand assembly of lower anchor assemblies 40 in FIG. 2. The particular structure and included elements of lower anchor assembly 40 may vary depending on the particular vehicle, the location of lower anchor tab 402, and the route taken from lower anchor tab 402 to the location on the vehicle where lower anchor assembly 40 attaches.

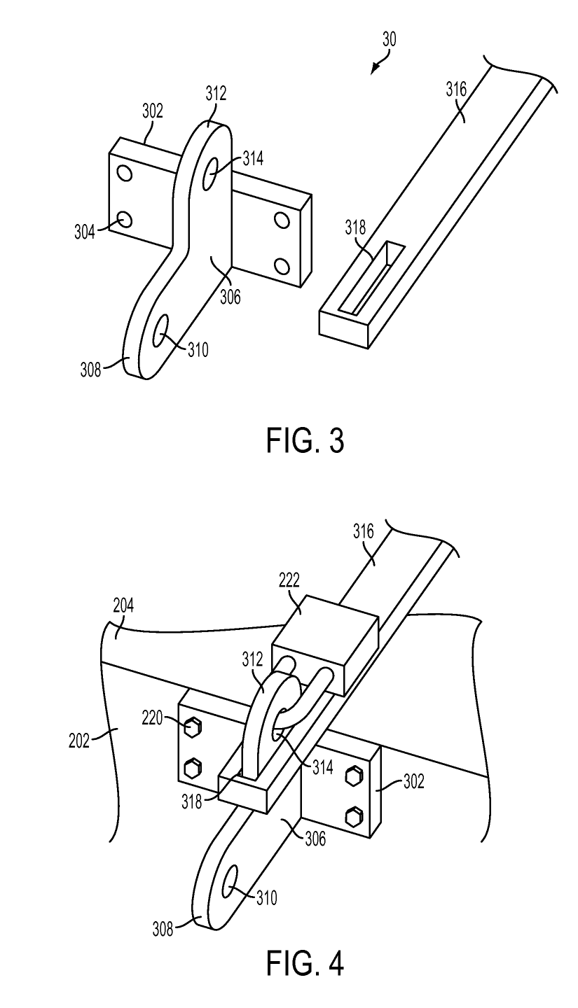

FIG. 3 is a perspective view of the unassembled elements of the upper anchor point assembly 30. Referring again to FIG. 3, one portion of the assembly elements is comprised of a base plate 302 and a connection plate 306. Base plate 302 has several screw apertures through it for attaching to the side of an emergency vehicle, such as vehicle 20 of FIG. 1. Connection plate 306 attaches to base plate 302 perpendicularly and extends from base plate 302. Connection plate 306 has an upwardly extending reinforcement tab 312 and a laterally extending upper anchor tab 308. Upper anchor tab 308 has upper anchor aperture 310 through it which provides an anchor point for the ropes of emergency rescuers. Reinforcement tab 312 has cotter pin aperture 314 through it and this cotter pin aperture 314 provides a means of retaining cross tie bar 316 in connection with connection plate 306. FIG. 3 shows a section of the end of cross tie bar 316 with receiving slot 318 in proximity to the end of cross tie bar 316.

FIG. 4 shows side 202 and top 204 of vehicle 20 with upper anchor point 30 assembled onto emergency vehicle 20. Base plate 302 is attached to side 202 of emergency vehicle 20 by screws, or bolts, 220 through screw apertures 304. Connection plate 306 is fixed to base plate 302 and extends away from base plate 302 and away from side 202. Upper anchor tab 308 extends from the lower portion of connection plate 306, presenting upper anchor aperture 310 for use by an emergency rescuer. Reinforcement tab 312 extends upwardly from connection plate 306 through receding slot 318 of cross tie bar 316. In FIG. 4, a padlock 222 passes through cotter pin aperture 314 to maintain cross tie bar 316 in assembly with connection plate 306. Although padlock 222 is shown in FIG. 4, other devices, such as a cotter pin with a retention clip, could be used for this purpose as well.

FIG. 5 shows a perspective view of the lower anchor assembly 40 not attached to emergency vehicle 20. Lower anchor tab 402 has lower anchor aperture 404 through it and this is the aperture presented for rescuers to use to anchor their rope. From lower anchor tab 402, lower anchor extension 406 runs back towards the parts of lower anchor assembly 40 that attach to emergency vehicle 20. At its end opposite to that of lower anchor tab 402, lower anchor extension 406 connects to angled riser 408 which then attaches to vertical riser 410. This brings lower anchor assembly 40 in proximity to a frame member. Frame engagement member 412 is shaped specifically to accommodate a frame member of a vehicle and attaches to vertical riser 410. Frame engagement 412 has two ends which terminate in joint flats 414 which have bolt apertures 416 through them. Frame engagement member 412 substantially encircles frame element 212. Frame capture member 418 has bolt apertures 420 through it which match those on joint flats 414 of frame engagement member 412. When attached through bolt apertures 420 to frame engagement member 412, frame capture member 418 completes the encirclement of a frame element of a vehicle. This mounts the lower anchor point assembly 40 to frame element 212 in such a way that a strong and stable anchor point is presented at the lower edge of the body of vehicle 20.

Returning now to FIGS. 1, 2, and 4, it may be seen that cross tie 316 spanning the top 204 of emergency vehicle 20 provides extra support for the screws or bolts that mount base plate 302 of anchor point 30 to the side 202 of emergency vehicle 20. This arrangement prevents the possibility of the threads on the screws, or bolts, from stripping due to a tensile load. In some embodiments, cross tie bar 316 creates a fulcrum at its interaction with connection plate 306 which actually drives base plate 302 back against side 202 of emergency vehicle 20. This transfers the tensile load of a rope attached at upper anchor aperture 310 to cross tie 316 and creates a compression load at base plate 302. Therefore, in some embodiments, the screws, or bolts, attaching base plate 302 to side 202 really only need to provide location. The tensile load in cross tie bar 316 is transmitted to the assembly on the other end, but the moment arm created by the interaction between cross tie bar 316 and connection plate 306 on the opposite side is minimal and does not endanger the strength of the threads of the screws on the opposite side.

The set of two lower anchor points 40 and single upper anchor point 30 on each side of emergency vehicle 20 provide the required number of redundant anchor points for a rescue worker. This allows a rescue worker to have the required points immediately available upon the emergency vehicle 20 arriving on a scene. This is highly advantageous and saves the time of locating anchor points at the scene and provides greater safety because of the known strength of the anchor points. It takes much needed time to locate and ascertain the quality of anchor points on location. In emergency situations that time is crucial to the life of the person being rescued.

While specific embodiments of the rescue anchor point system has been discussed, it should be emphasized that the scope of the current application is not limited to those specific embodiments. Rather, the figures, detailed description, and the abstract are provided to give a person of ordinary skill in the art an understanding of the invention. Some embodiments of the anchor point system may be retrofitted to emergency vehicles already in use.

The anchor point system may be used in other applications and with different types of vehicles and the particular application and vehicle may lead to different embodiments of the anchor point system being employed. For example, utility crews often must work in rough terrain and could benefit from installation of the anchor point system to their vehicles. Their vehicles and requirements could lead to an embodiment varying from those shown in the drawing figures but still within the scope of this application. Also, any situation where dependable anchor points are in need could benefit from the presence of a vehicle with the system installed on it. For example, boats need to be tied to shore when parked and when there is not a dock present specifically for that purpose, a reliable tie off point needs to be found. The presence of a vehicle with an embodiment of the anchor point system installed on it would provide just such a reliable tie off point.

We claim:

1. An anchoring system for use with a vehicle, comprising:
a first anchor assembly, a second anchor assembly, and a third anchor assembly,
said first anchor assembly comprising a base attached to said first side of said vehicle and a first connection member extending from said base, said first connection member having a first anchor aperture through it,
said second anchor assembly being located beneath said body of said vehicle and having a first end and a second end, said first end of said second anchor assembly located proximal to said first side and said second end of said second anchor assembly extending under said vehicle and attaching to said vehicle, said first end of said second anchor assembly having a second anchor aperture through it,
said third anchor assembly being located beneath said body of said vehicle and having a first end and a second end, said first end of said third anchor assembly located proximal to said first side and having a third anchor aperture through it, said second end of said third anchor assembly extending under said vehicle and attaching to said vehicle underneath said body of said vehicle.

2. The anchoring system of claim 1, wherein:
said anchoring system includes a frame member having a first and second end and attached to the underside of the body of said vehicle, such that said second anchor assembly is attached to the first end of said frame member, and said third anchor assembly is attached to said second end of said frame member.

3. The anchoring system of claim 2, wherein:
said second end of said second anchor assembly terminates in a frame engagement member, and said second anchor assembly further comprises a frame capture member, said frame capture member attaching to said frame engagement member to encircle said frame member to attach said second anchor assembly to said frame member, and
said second end of said third anchor assembly terminates in a frame engagement member, and said second anchor assembly further comprises a frame capture member, said frame capture member attaching to said frame engagement member to encircle said frame member and attach said third anchor assembly to said frame member.

4. The anchoring system of claim 1, wherein:
said first anchor assembly is attached to said first side proximal to said top of said vehicle, and
said anchoring system further comprises a cross tie having a first end and a second end, said first end of said cross tie attaching to said first anchor assembly and said second end of said cross tie attaching to said second side of said vehicle.

5. The anchoring system of claim 1, wherein one or more of said anchors can be laterally extended away from said vehicle.

6. The anchoring system of claim 4, further comprising:
a fourth anchor assembly, said fourth anchor assembly comprising a base attached to said second side in proximity to said top and a second connection member extending from said base of said fourth anchor assembly and a second, said first connection member having a first anchor aperture through it, having a fourth anchor aperture comprising an extension having a first end and second end connection plate extending from said base, said connection plate having a first anchor aperture through said vehicle.

7. An anchoring system for use with a vehicle, comprising a plurality of anchor assemblies, each of said anchor assemblies comprising a base attached to said vehicle and a connection member extending from said base such as to serve as an anchoring point.

8. The anchoring system of claim 7 wherein at least one of said anchoring assemblies is mounted on or near the bottom of said vehicle.

9. The anchoring system of claim 8 wherein at least one of said anchoring assemblies is mounted on or near the top of said vehicle.

10. A vehicle with an anchoring system for ropes, comprising:
a vehicle comprising a body having a first side, a second side, and a top; and,
an anchoring system comprising a first anchor assembly, a second anchor assembly, and a third anchor assembly,
said first anchor assembly comprising a base attached to said first side of said vehicle and a first connection member extending from said base, said first connection member having a first anchor aperture through it,
said second anchor assembly being located beneath said body of said vehicle and having a first end and a second end, said first end of said second anchor assembly located proximal to said first side and said second end of said second anchor assembly extending under said vehicle and attaching to said vehicle, said first end of said second anchor assembly having a second anchor aperture through it,
said third anchor assembly being located beneath said body of said vehicle and having a first end and a second end, said first end of said third anchor assembly located proximal to said first side and having a third anchor aperture through it, said second end of said third anchor assembly extending under said vehicle and attaching to said vehicle underneath said body of said vehicle.

11. The vehicle with an anchoring system for ropes of claim 10, wherein:
said vehicle further comprises a frame member beneath said body, and said second end of said second anchor assembly and said second end of said third anchor assembly attach to said frame member.

12. The vehicle with an anchoring system for ropes of claim 11, wherein:
said second end of said second anchor assembly terminates in a frame engagement member, and said second anchor assembly further comprises a frame capture member, said frame capture member attaching to said frame engagement member to encircle said frame member to attach said second anchor assembly to said frame member, and
said second end of said third anchor assembly terminates in a frame engagement member, and said second anchor assembly further comprises a frame capture member, said frame capture member attaching to said frame engagement member to encircle said frame member and attach said third anchor assembly to said frame member.

13. The vehicle with an anchoring system for ropes of claim 10, wherein:
said first anchor assembly is attached to said first side proximal to said top of said vehicle, and
said anchoring system further comprises a cross tie having a first end and a second end, said first end of said cross tie attaching to said first anchor assembly and said second end of said cross tie attaching to said second side of said vehicle.

14. The vehicle with an anchoring system for ropes of claim 13, further comprising:
a fourth anchor assembly, said fourth anchor assembly comprising a base attached to said second side in proximity to said top and a second connection member extending from said base of said fourth anchor assembly and a second, said first connection member having a first anchor aperture through it, having a fourth anchor aperture comprising an extension having a first end and second end connection plate extending from said base, said connection plate having a first anchor aperture through it.

15. A kit for retrofitting a rope anchoring system to a vehicle having a body with a first side, a second side, and a top, said kit comprising:
a vehicle comprising a body having a first side, a second side, and a top; and,
an anchoring system comprising a first anchor assembly, a second anchor assembly, and a third anchor assembly,
said first anchor assembly comprising a base attached to said first side of said vehicle and a first connection member extending from said base, said first connection member having a first anchor aperture through it,
said second anchor assembly being located beneath said body of said vehicle and having a first end and a second end, said first end of said second anchor assembly located proximal to said first side and said second end of said second anchor assembly extending under said vehicle and attaching to said vehicle, said first end of said second anchor assembly having a second anchor aperture through it,
said third anchor assembly being located beneath said body of said vehicle and having a first end and a second end, said first end of said third anchor assembly located proximal to said first side and having a third anchor aperture through it, said second end of said third anchor assembly extending under said vehicle and attaching to said vehicle underneath said body of said vehicle.
